(19) United States
(12) Patent Application Publication
(10) Pub. No.: US 2025/0029278 A1
(43) Pub. Date: Jan. 23, 2025

(54) MULTI-WAVELENGTH ACTIVE MARKER FOR MULTI-CAMERA SYSTEMS, AND RELATED METHODS OF CALIBRATION

(71) Applicant: NaturalPoint, Inc., Corvallis, OR (US)

(72) Inventors: Matthew Todd SMITH, Corvallis, OR (US); Stuart GUARNIERI, Laramie, WY (US); Anthony Louis LAZZARO, Corvallis, OR (US); Marc Wayne ALLEY, Corvallis, OR (US); William Francis HAYES, III, Philomath, OR (US)

(21) Appl. No.: 18/353,810

(22) Filed: Jul. 17, 2023

(51) Int. Cl. G06T 7/80; H04N 23/90; H04N 25/10

(52) U.S. Cl. CPC G06T 7/80; G02B 23/04; H04N 23/90; H04N 25/10; G06T 2207/30204

(57) ABSTRACT

A multi-wavelength active marker includes a first light source emitting a first wavelength of light, a second light source emitting a second wavelength of light different from the first wavelength, and a converging light-combining waveguide that is arranged adjacent the first and the second light sources. The waveguide guides the light emitted from the first and second light sources to a diffuser for concurrent emission of both of the first and second wavelengths from the diffuser. The multi-wavelength active marker may be used in co-calibration of disparate camera systems, such as a motion capture camera system and a cinema camera, which are not sensitive to the same wavelengths for calibration purposes.

### TECHNICAL FIELD

The present disclosure is generally related to the calibration, alignment, and/or the synchronization of multiple cameras, image sensors, and/or other sensor technologies. More particularly, the present disclosure relates an active marker that emits light of more than one wavelength, and a calibration wand with one or more such multi-wavelength active markers, usable in the calibration, alignment, and/or the synchronization of multiple cameras, image sensors, and/or other sensor technologies, such as image sensors in a motion-capture system, and to related methods of calibration and tracking of objects.

### BACKGROUND

Motion capture systems may be used to track movement(s) of a person, animal, or other object to which a computer model may be mapped to produce animation that accurately imitates real-world movement(s). Further, motion capture may allow movement for animation to be produced in a quick manner relative to frame-by-frame animation. The quick production time may permit an animation director to experiment with different movements or perspectives before mapping the movement to computer models, which may result in more flexible animation production.

Motion capture technology is also known for use in producing cinematic special effects. For example, a motion capture system may be utilized in conjunction with one or more cinema cameras to record a scene and simultaneously record the positions and movements of persons and items in the scene, and optionally the position, orientation, and movement of the cinema camera(s). The information on the positions and movements can then be utilized to produce or overlay animations or other special effects onto the scene recorded by the cinema camera(s).

Conventional motion-capture systems include multiple cameras or image sensors that detect one or more objects (including persons) within a capture volume around which the cameras or image sensors are positioned. One or more active markers with light-emitting devices, or passive markers such as retroreflectors, can be attached to the objects to facilitate precise location of the objects and parts thereof. For example, markers may be attached to key locations on a person, such as their head, nose, chin, chest, hands, fingers, joints, etc. In order to accurately capture positional information via the motion capture cameras or image sensors, e.g., via triangulation, it is necessary for the cameras or image sensors to be calibrated to account for their relative positions and orientations, and adjust for any synchronization errors. Such calibration methods may involve moving one or more active markers, or a calibration wand with one or more active markers, within the capture volume during the calibration routine, as described in U.S. Pat. No. 9,019,349 to Richardson, which is assigned to the assignee of the present application and incorporated herein by reference.

Some motion capture camera systems include image sensors that are sensitive to light waves of a particular wavelength, such as an infrared (IR) wavelength, allowing greater sensitivity to active markers emitting such wavelengths. Some motion capture cameras may also emit light waves of the particular wavelength to which their image sensors are sensitive, such as IR light of a particular wavelength, which is then reflected back to the motion capture camera by passive markers such as retroreflectors. Cinema cameras or other reference cameras that may be used in conjunction with a motion capture system have excellent fidelity in the visible spectrum, but may not be sensitive to IR light or to another wavelength of light utilized by the motion capture cameras, or may purposefully filter IR light or other wavelengths to improve color balance and video quality. Consequently, the calibration and synchronization of a cinema camera (or other reference camera) with a motion capture system may be complicated by the cinema cameras' lack of sensitivity to the wavelengths of light emitted by the active markers utilized by the motion capture cameras.

One known method of calibrating disparate camera systems sensitive to two different wavelengths involves the use of a T-shaped calibration wand having pairs of two different types of light-emitting diodes (LEDs) (i.e., active markers) mounted thereon—one that emits red light and one that emits IR light. The pairs of LEDs are spaced apart on the body of the wand, and within each pair the red and IR LEDs are positioned in side-by-side relation. The present inventors have recognized that the separation distance between the red and IR LEDs of each pair may lead to calibration errors as between the disparate camera systems. The red and IR LEDs are also recessed below the outer surface of the wand body, which limits the angle of emission of the LEDs and can result in one or both of the LEDs being occluded by the body of the wand and/or the other LED, depending on the orientation of the wand relative to the camera.

A need remains for a more accurate and reliable method of calibrating and synchronizing two or more camera systems sensitive to different wavelengths of light, and/or for improved active markers and calibration wands for use with such disparate co-calibrated camera systems.

### BRIEF SUMMARY

A multi-wavelength active marker for image capture systems, such as a motion capture system, includes a first source emitting a first light wave having a first wavelength and a second source emitting a second light wave having a second wavelength different from the first wavelength. A waveguide is arranged adjacent the first source and the second source so that the first and the second light waves are transmitted into a first end of the waveguide and guided along the waveguide to a second end thereof, preferably through total internal reflection at the sides of the waveguide. A diffuser attached to the second end of the waveguide receives the first and second light waves and diffuses and emits them from the diffuser.

The waveguide may be shaped to converge the first and the second light waves from the first end to the second end, and the diffuser may be sized and shaped so that the first and second wavelengths are emitted from the diffuser with an emission angle of more than 180 degrees. For example, the diffuser may have a spherical emission surface.

In some embodiments, the first source is an LED that emits infrared (IR) or near-IR light, and the second source is an LED that emits visible light, such as red light. The first source and the second source may be mounted on a printed circuit board (PCB) adjacent one another in spaced-apart relation.

The multi-wavelength active markers may be used in a motion-capture system that may include a calibration wand having one or more of the multi-wavelength active markers. The calibration wand may comprise a T-shaped body with an elongated handle and a head extending transversely to the elongated handle, and with a plurality of the multi-wavelength active markers supported on the head. In some embodiments, the calibration wand may include three or more such multi-wavelength markers irregularly spaced apart. The motion capture system may include first and second camera systems, including a first camera system sensitive to the first wavelength of light; and a second camera system sensitive to the second wavelength of light and not sensing the first light wave.

Methods of calibrating camera systems are also disclosed, which include the steps of waving a calibration wand having one or more of the multi-wavelength active markers while emitting first and second light waves from a common emission surface of each of the markers, capturing the first light wave using one or more first sensors sensitive to the first wavelength, and capturing the second light wave using one or more second sensors sensitive to the second wavelength. The first and second sensors are then calibrated in response to capturing the respective first and second light waves from the multi-wavelength markers.

Additional aspects and advantages will be apparent from the following detailed description of exemplary embodiments, which proceeds with reference to the accompanying drawings.

### BRIEF DESCRIPTION OF THE DRAWINGS

FIG. 1 is a simplified pictorial view of a motion-capture system and calibration tools.

FIG. 2A is a side view of a multi-wavelength active marker.

FIG. 2B is an exploded assembly side view of the multi-wavelength marker of FIG. 2A.

FIG. 3 is an isometric view of a calibration wand carrying three multi-wavelength active markers of the kind illustrated in FIG. 2A.

FIGS. 4A and 4B are partially-exploded views of the wand of FIG. 3, with FIG. 4B providing a detailed exploded view of one of the multi-wavelength active markers and a protective cover thereof.

FIG. 5 is a left side end view of the calibration wand of FIG. 3.

FIGS. 6A and 6B are cross-sectional views of the wand of FIG. 3 taken along line 6-6 in FIG. 5, with FIG. 6B providing a detail view of one of the multi-wavelength markers.

FIG. 7 illustrates a method for calibrating a reference camera with a motion-capture system utilizing the calibration wand of FIG. 3.

### DETAILED DESCRIPTION OF EXEMPLARY EMBODIMENTS

This disclosure describes apparatuses, systems, and methods used to calibrate, align, and/or synchronize a plurality of cameras, image sensors, and/or other sensor technologies, which may be embedded in or on a motion-capture system. To achieve accurate calibration, alignment, and/or synchronization of the cameras, image sensors, and/or other sensor technologies, this disclosure describes a multi-wavelength active marker and a calibration wand. The calibration wand may include one or more multi-wavelength active markers.

In one aspect, the multi-wavelength active marker includes a first source that emits a first electromagnetic wave (first light) having a first wavelength, and a second source that emits a second electromagnetic wave (second light) having a second wavelength different from the first wavelength. The multi-wavelength active marker also includes a waveguide with a first end and a second end, where the waveguide is mechanically coupled to the first source and the second source so that the first and the second light waves are transmitted into the first end of the waveguide. The waveguide of the multi-wavelength active marker guides light from the first and second light sources from the first end to the second end. The multi-wavelength active marker also includes a diffuser that is mechanically coupled to second end of the waveguide, where the diffuser diffuses the first and the second light waves. Thus, the emissions of the first and second light sources are optically aligned with one another, which facilitates calibration of disparate cameras or imaging systems sensitive to the different wavelengths of light.

In another aspect, even though the multi-wavelength active marker described herein includes at least two sources (e.g., light sources), the multi-wavelength active marker behaves, or operates, like having a single source that emits a first electromagnetic wave having a first wavelength and a second electromagnetic wave having a second wavelength that is different from the first wavelength.

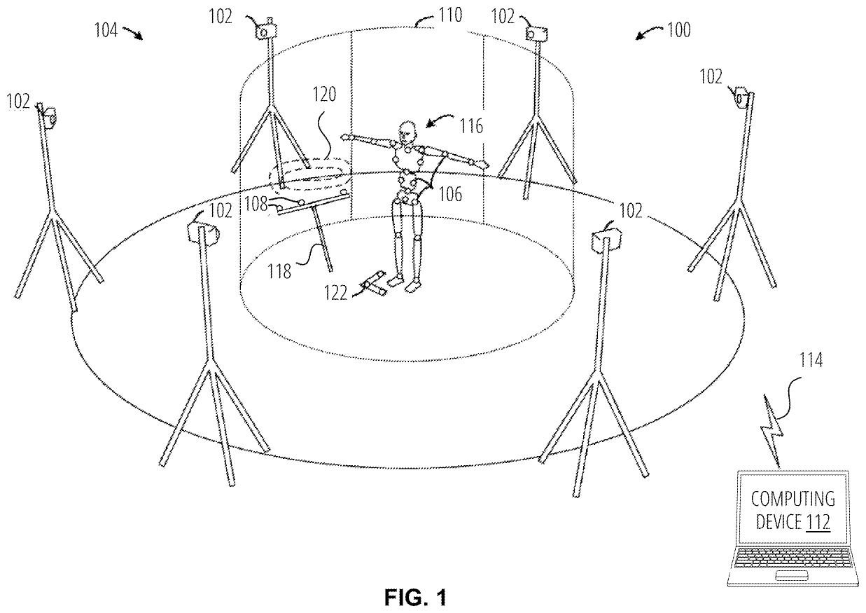

FIG. 1 illustrates a motion-capture system 100 providing an environment of use for the inventions described herein. In some embodiments, the motion-capture system 100 may be configured to capture video, static images, or combinations thereof. The motion-capture system 100 comprises a plurality of cameras 102 having image sensors that are configured to receive light or other electromagnetic waves from a scene 104, which may include ambient light reflected from objects in the scene 104, light reflected from passive markers, light emitted by active markers, electromagnetic waves from other sources, and combinations thereof.

For the sake of clarity, as used herein, the terms “light” and “light waves” may include infrared (IR) waves, IR radiation or IR light; near-IR waves, near-IR radiation, or near-IR light; visible light; and ultraviolet (UV) waves, radiation, and/or light. And the term “electromagnetic waves” may include light, infrared (IR) waves, IR radiation or IR light; near-IR waves, near-IR radiation, or near-IR light; visible light; ultraviolet (UV) waves, radiation, or light; X-rays; gamma rays, microwaves, radio waves, etc. For the sake of brevity, however, the present disclosure generally focuses on the use of IR or near-IR light and the use of visible light. Generally, IR light includes light having approximately an 800 nanometer (nm) to 1 millimeter (mm) wavelength, and near-IR light includes light having approximately an 800 to 2500 nm wavelength. Visible light may include red light (approximately 620 to 780 nm wavelength); orange light (585 to 620 nm); yellow light (570 to 585 nm); green light (490 to 570 nm); blue light (440 to 490 nm); indigo light (420 to 440 nm); violet light (400 to 420 nm); combinations thereof (e.g., a white light), or any specific range of wavelengths in the visible spectrum. It is to be understood that there is an inverse relation between the wavelength and the frequency of a light or any other electromagnetic wave. That is, a shorter first wavelength translates to a higher frequency of the electromagnetic wave, and vice versa.

FIG. 1 illustrates six example cameras 102 that are distributed around a capture volume 110 to capture views of the scene 104 from different angles. By so doing, the cameras 102 can collectively view and/or capture substantially all surfaces of objects in the capture volume 110, thereby providing a 360-degree view of the capture volume 110. The capture volume 110 is a three-dimensional (3D) space that is collectively visible to and/or captured by some or all of the cameras 102.

In some embodiments, the motion-capture system 100 may include additional or fewer cameras 102 than what is illustrated in FIG. 1. For example, the cameras 102 of the motion-capture system 100 may be spatially arranged to capture a less-than-360-degrees view of the scene 104, such as a 90-degree view, a 180-degree view, a 270-degree view, or another view. For example, a director, a camera operator, an actor, or generally a user may decide to only capture a portion of the scene 104. In that case, some of the cameras 102 may be omitted from the scene 104. Therefore, the size and shape of the volume 110 depends on the count, the spatial arrangement, and/or the location(s) of the cameras 102.

In some embodiments, the user (e.g., the director, the camera operator) may use a computing device 112 to operate the cameras 102. The computing device 112 communicates with the cameras 102 using a communication link 114, which may comprise wired and/or wireless communication links.

Communication(s) in the environment of FIG. 1 may be performed using various protocols and/or standards. Examples of such protocols and standards include: an Institute of Electrical and Electronics (IEEE) 802.3 Ethernet standard, a 3rd Generation Partnership Project (3GPP) Long-Term Evolution (LTE) standard, such as a 4th Generation (4G) or a 5th Generation (5G) cellular standard; an IEEE 802.11 standard, such as IEEE 802.11g, ac, ax, ad, aj, or ay (e.g., Wi-Fi 6® or WiGig®); an IEEE 802.16 standard (e.g., WiMAX®); a Bluetooth® Classic standard; a Bluetooth® Low Energy or BLE standard; an IEEE 802.15.4 standard (e.g., Thread® or ZigBee®); other protocols and/or standards that may be established and/or maintained by various governmental, industry, and/or academia consortiums, organizations, and/or agencies; and so forth. In addition to, or alternatively of, the communication link 114 illustrated in FIG. 1, the motion-capture system 100 may facilitate and/or utilize other unidirectional, bidirectional, wired, wireless, direct, and/or indirect communications utilizing one or more communication protocols and/or standards. Therefore, FIG. 1 does not necessarily illustrate all means of communication.

To facilitate motion capture, objects and bodies 116 in the capture volume 110 may be fitted with one or more markers 106 that are more easily identified by cameras 102 and motion capture software used therewith. Body 116 may belong to a person (e.g., actor, supporting staff), and the markers 106 may correspond to different joints or points of the person. In some embodiments, the body 116 may belong to an animal. In some embodiments, the body 116 may represent an object, such as a mechanized object.

In some embodiments, the markers 106 are passive markers that reflect incident light to enhance the brightness or the signal of the markers 106, and the cameras 102 can detect the reflected incident light. In some embodiments, each, some, or all of the cameras 102 may include a light source(s) that is/are substantially coaxially aligned with an axis extending perpendicularly outward from each of the camera(s) to provide illumination to the markers 106. The markers 106 of a passive variety may include retro-reflective material with corner cube reflectors, or other structures, patterns, and/or configurations to reflect incident light back to its source regardless of its angle of incidence. In some embodiments, the sources (e.g., light sources) of the cameras 102 provide IR light, near-IR light, visible light or combinations thereof that may be reflected by the corner cube reflectors of the markers 106 back toward the cameras 102 to relatively enhance light from the markers 106 relative to other elements of the scene.

In some embodiments, the markers 106 are active markers that emit their own light, instead of, or in addition to, reflecting incident light. In a preferred embodiment, the cameras are sensitive to active markers that emit IR light.

Regardless of the markers 106 being active or passive markers, the markers 106 may be associated with a body 116 located in the volume 110 and/or the scene 104. In some embodiments, the body 116 may be a moving body, a static body, or a combination thereof (e.g., sometimes moving, other times static). In some embodiments, one or more of the markers 106 may include or emit an identifier (e.g., a pulse-modulated code or label, or an electronic tag synchronized with light emissions) in order to track the motion and/or the position of specific objects in the capture volume 110 or specific markers 106 on the body 116.

One type of camera operation may be referred to herein as a “marker-tracking mode,” which may produce a marker-tracking view of the scene 104 using, in part, the computing device 112. When operating in the marker-tracking mode, a combination of optical filters, components, firmware, and/or software of a camera 102 and/or the computing device 112 may be used to facilitate detection of the markers 106, as well as distinguish those markers from other elements in the scene 104 and/or the body 116.

When the cameras 102 operate in the marker-tracking mode, the position of the markers 106 is determined from the scene data recorded by the cameras 102. In some embodiments, the cameras 102 send marker position data to the computing device 112, which then calculates the marker positions through triangulation from the location of marker position data in the scenes simultaneously captured by different cameras from different angles. The position(s) of the markers 106 correspond to the movement of a person(s), animal(s), and/or object(s), which may be mapped by the computing device 112 to a three-dimensional (3D) model for computer-aided animation.

In some embodiments, the cameras 102 may be configured to enhance light from the scene 104 by, for example, increasing the signal-to-noise ratio (SNR) of the scene 104 in order to make markers 106 appear brighter relative to other elements of the scene 104. For example, the SNR may be increased by increasing the gain of the cameras 102. As another example, the SNR may be increased by filtering light received by the image sensor(s) that may be embedded in or on the camera 102. The sensor(s) may be any combination of one or more IR sensors, visible (or optical) light sensors, UV light sensors, hyperspectral image sensors, and/or other image sensors. In some embodiments, by detecting the scene 104 where light from the markers 106 is relatively enhanced, the markers 106 may be more easily identifiable by a motion-capture program that may be executed using the computing device 112.

Furthermore, each, some, or all of the cameras 102 that are configured to operate in the marker-tracking mode may also be configured to enhance light from the scene 104 to a lesser extent than in the marker-tracking mode. That is, one or more of the cameras 102 may be configured to detect the scene 104 at an SNR that is different than the SNR used during the marker-tracking mode. For example, the SNR may be lowered such that the scene 104 is detected at an SNR that approximates normal video recording, where elements of the scene 104 are substantially not skewed through light enhancement or other methods. In other words, the brightness of markers 106 may be enhanced to a lesser extent, or not at all, relative to other elements of the scene 104. This more balanced type of camera operation may be referred to herein as a “scene mode,” which may produce a view of the scene 104 using, in part, the computing device 112.

Cameras 102 that are operable in the scene mode may be controlled (e.g., remotely) by the computing device 112 to selectively transition between the marker-tracking mode and the scene mode. In some cases, each, some, or all of the cameras 102 in the motion-capture system 100 may be selectively configured to operate in the marker-tracking mode, in the scene mode, or a combination of these modes. It should be appreciated that many different configurations and combinations are possible.

In some embodiments, the captured volume 110 may be defined based on, or as a result of, a camera calibration procedure, in which each of the cameras 102 perform a given calibration step substantially simultaneously (or concurrently). During calibration, the cameras 102 are simultaneously set to operate in marker-tracking mode, so that all of the cameras 102 detect the position and/or movement of markers 106 for calibration.

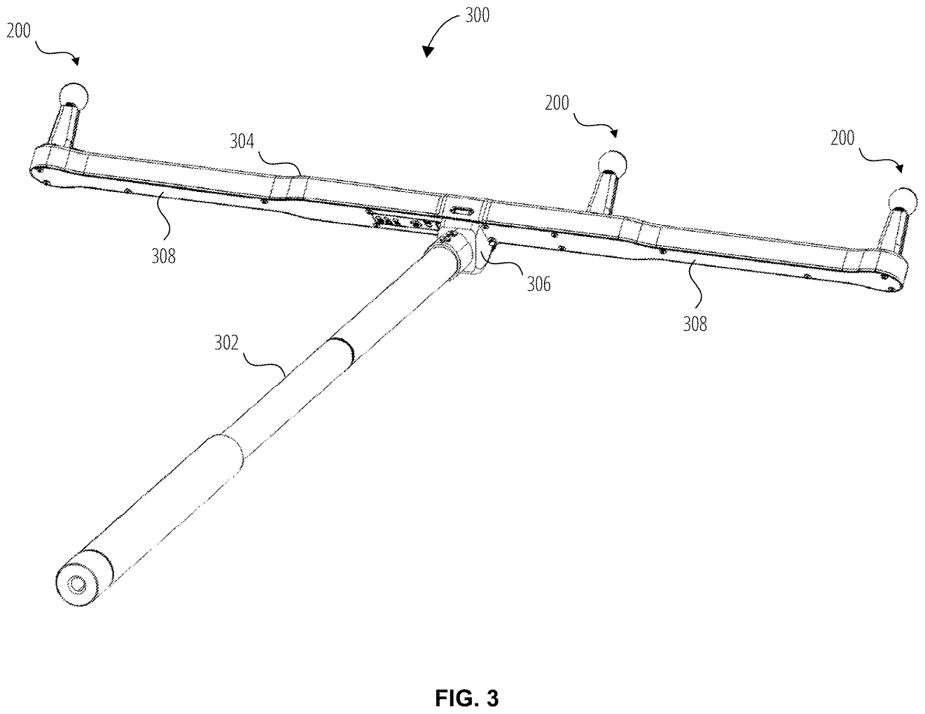

In some embodiments, the calibration procedure may involve a user (e.g., an actor, a supporting staff) moving a calibration wand 118 about an area, as is illustrated by a movement 120, wherein the calibration wand has one or more active markers 108 mounted thereon. The active markers 108 are detected by the cameras 102 in order to create data points organized into a calibration data set from which the captured volume 110, or a portion thereof, may be defined. The active marker 108 illustrated in FIG. 1 is a single marker mounted on top of the calibration wand 118. However, the calibration wand 118 may be of a type including multiple active markers, as described herein with reference to FIG. 3.

In some embodiments, a marker-defined reference plane 122 (“reference plane 122”) may be placed on the ground within the volume 110 and may be detected to create data points that are interpolated to define the plane at which the ground resides in the volume 110. For example, the plane defined by the reference plane 122 ties the position data captured by the cameras 102 to world coordinates that are local to the volume 110. As another example, various different patterns may be used to create data points, such as a grid or checkerboard pattern. It will be appreciated that, in some embodiments, the volume 110 and the camera calibration may be achieved in any suitable manner utilizing any suitable reference object (e.g., wand 118) and/or marker-defined reference plane (e.g., reference plane 122).

In some embodiments, as part of the calibration procedure, a calibration data set of data points created as a result of detecting movement of the active marker 108 and detecting the position of the reference plane 122 may be used to determine intrinsic and extrinsic properties of each of the cameras 102 using minimization techniques. The intrinsic and extrinsic properties may define parameters of each of the cameras 102 that produce a given photograph (or still) image or video (e.g., a sequence of image frames). The intrinsic properties may include parameters that define lens properties, a focal length, a distortion, pixels, pixels-per-degree, an image format, a principal point relative to the camera itself, and other intrinsic parameters. The extrinsic properties may include parameters that define a position of a camera center and the cameras heading in world coordinates and may be defined relative to the other cameras.

The solution to the calibration data set resulting from application of the minimization techniques that includes optimization of the intrinsic and extrinsic parameters of each camera may be represented, for example, by a series of transformations (e.g., a matrix of camera intrinsic parameters, a three-by-three (3×3) rotation matrix, a translation vector, etc.). The series of transformations may be referred to as a camera projection matrix.

In some embodiments, the camera projection matrix can be used to associate points in a camera's image space with locations in 3D world space. The camera calibration procedure may provide a solution to the calibration data set of position data received from each camera 102. The solution to the calibration data set may define the intrinsic and extrinsic properties of each camera 102. Since the same solution may be used for calibration of all of the cameras 102, the intrinsic and extrinsic properties may be interpolated more quickly and easily by applying minimization techniques than by calibrating each camera 102 individually. Therefore, each camera 102 may be calibrated substantially simultaneously (or concurrently) to reduce calibration time. Nevertheless, in some embodiments, each camera 102 may be calibrated using the solution to the calibration data set without simultaneous calibration. Regardless of the particular timing of calibration or a given calibration step, it may be a substantial benefit to avoid having to use an entirely separate procedure to calibrate scene mode cameras.

It will be appreciated that the captured volume 110 and camera calibration may be achieved in any suitable manner. For example, various different types of reference markers (e.g., markers of the reference plane 122, active markers 108) may be used to create data points for interpolation of the intrinsic and extrinsic properties of each camera 102. As another example, various different patterns may be used to create data points, such as a grid or checkerboard pattern. Since the cameras 102 may be collectively calibrated using the same solution to the calibration data set, a marker-tracking view produced by cameras operating in the marker-tracking mode, and a scene view produced by cameras operating in the scene mode, may be automatically calibrated. Consequently, when the marker-tracking view is overlaid with the scene view, the markers 106 align with corresponding points on the moving (or static) body 116 (e.g., a person's joints and/or points of motion). The proper alignment of the marker 106 with the body 116 can be achieved because of the camera calibration procedure during which the properties of the camera are learned.

Subsequent to the camera calibration, in some embodiments, the computing device 112 can create a composite and/or an overlay view where at least a portion of the marker-tracking view is overlaid on the scene view, or at least on a portion thereof. Creation of the composite and/or the overlay may be enabled based on calibration of the cameras 102 and the resulting solution to the calibration data set. Since the cameras 102 are calibrated, the markers 106 (that may be relatively enhanced compared to the scene 104) can be overlaid with the body 116 in the scene 104 so that the markers 106 are suitably aligned with points of movement (e.g., joints, head, etc.) of the body 116.

In some embodiments, the composite and/or the overlay view may have many useful applications that can be leveraged to improve accuracy and efficiency during a motion-capture session. For example, the composite view may be used to verify that the positions of the markers 106 correspond to the actual movement of the body 116. As another example, the composite view may be used to reconstruct situations when the markers 106 do not correctly represent movement and/or position of the body 116 in order to diagnose and solve the problem. As another example, the composite view may be enhanced by importing virtual objects, such as animations or models, that are aligned with the markers 106. As another example, in a motion capture session for, for example, a movie, a director may view a composite view of an actor (e.g., the body 116) and a model of a costume that may be imported into the composite view and be fitted to the markers 106. Since the markers 106 are aligned with the points of movement of the actor, the costume may accurately move as the actor (e.g., body 116) moves in the scene view. As another example, the composite view may be used to by the director to quickly try different sets, costumes, camera angles, etc. that may facilitate more efficient use of a motion capture session, which may result in shorter capture sessions and reduced production costs. As another example, during a motion-capture session, one or some cameras may operate in the marker-tracking mode, and another or other cameras may operate in the scene mode. As yet another example, for every five cameras that operate in the marker-tracking mode, one camera may operate in the scene mode. This configuration may facilitate accurate marker tracking, while still being able to produce a composite view that includes at least some of the marker-tracking view overlaid on at least some of the scene view.

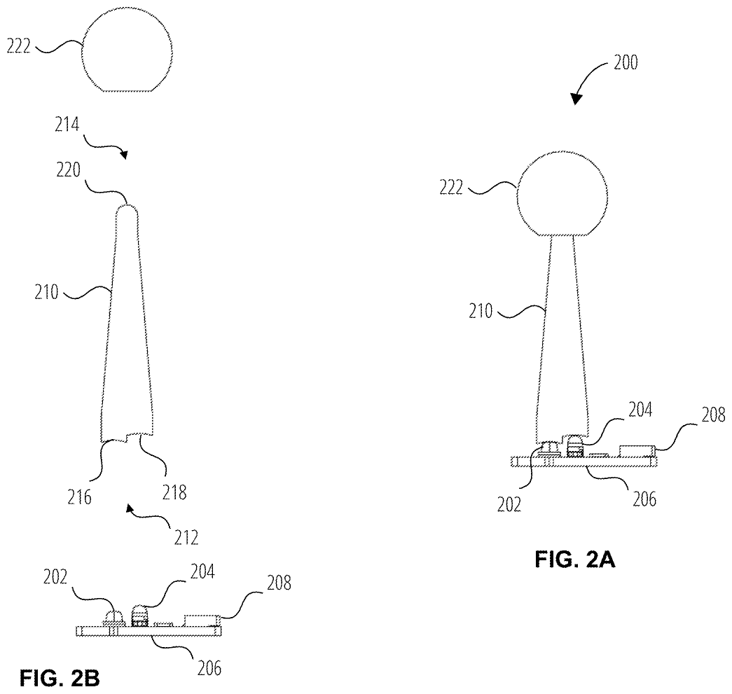

In some embodiments, one or more of the cameras 102 may be a cinema camera or other reference camera that is sensitive to visible wavelengths, but not sensitive to the IR wavelengths to which other ones of the cameras 102 are sensitive, or which may filter IR wavelengths to improve the fidelity of color reproduction. In some embodiments, the reference camera may have an image sensor that is sensitive to both visible and IR wavelengths but may optionally use an IR filter that prevents IR wavelengths from being transmitted to the image sensor and being sensed by the image sensor. In some embodiments (not illustrated) a cinema camera or other reference camera may be located within the capture volume 110 and may be an object having a marker that is tracked by motion tracking cameras 102. To facilitate use of motion capture data in conjunction with the visible scene captured by the reference camera, it is useful for the reference camera to be calibrated and synchronized with the motion capture cameras 102 (e.g. co-calibrated). However, the reference camera may not be configured to sense IR light emitted by a conventional active marker 108 of wand 118. Accordingly, the present inventors have created a multi-wavelength active marker for use as active marker 108 of wand 118 to simultaneously emit both IR wavelengths, and a visible wavelength, such as red light, for use in simultaneously or substantially simultaneously calibrating the motion capture cameras 102 and the reference camera together. Alternatively, all of the cameras 102, including the reference camera, may be sensitive to both visible and IR wavelengths, but with some cameras calibrated using IR wavelengths, while others, such as the reference camera, are calibrated using visible wavelengths. Methods for calibrating and synchronizing reference cameras with motion capture cameras may utilize a software calibration routine and methodology similar to the conventional methodology described above in the context of a group of motion capture cameras that are all operative to receive IR—with the main difference being the use of multi-wavelength active markers and disparate camera systems that are sensitive to different active marker wavelengths. Exemplary embodiments of a multi-wavelength marker and a calibration wand using such markers are described below with reference to FIGS. 2A, 2B, 3, 4A, 4B, 5, 6A, and 6B.

With reference to FIGS. 2A and 2B, a multi-wavelength active marker 200 may include a first source (e.g., a first light source) that emits a first light wave having a first wavelength, and a second source (e.g., a second light source) that emits a second light wave having a second wavelength that is different from the first wavelength. As is illustrated in FIGS. 2A and 2B, the multi-wavelength active marker 200 may include a first source in the form of an IR LED 202 (or a near-IR LED) that emits IR light (or near-IR light) and a second source in the form of a visible LED 204 that emits visible light. The IR LED 202 is located adjacent to the visible LED 204. Depending on the type of the visible LED 204, the visible LED 204 may emit a particular light in the visible light spectrum, for example, red light. In some embodiments, the multi-wavelength active marker 200 may include more than two sources of light, and each may emit distinct and/or different wavelengths from the others.

As is illustrated in FIGS. 2A and 2B, the IR LED 202 and the visible LED 204 may be mounted on a printed circuit board 206 (“PCB 206”). The PCB 206 may include various signal traces and circuitry that may include power and/or driver circuits for the LEDs 202, 204. In some embodiments, a connector 208 is provided for connecting to a power source and/or an LED controller or driver circuit (not illustrated), that may selectively determine, or set, the timing, the pattern, the power, the phase, and/or the duty cycle of the IR (or near-IR light) that is emitted from the IR LED 202 and the timing, the pattern, the power, the phase, and/or the duty cycle of the visible light that is emitted from the visible LED 204. In some embodiments, the IR LED 202 and the visible LED 204 may emit respective light waves (e.g., IR or near-IR light, visible light) substantially simultaneously. For example, the circuitry 208 can control the emission timing of the IR light (or near-IR light) being emitted from the IR LED 202 to coincide with the emission timing of the visible light being emitted from the visible LED 204. In some embodiments, the duty cycle of the visible light may be greater (longer) than the duty cycle of the IR light. In some embodiments, the circuitry 208 can align the active portion of the duty cycle of the IR LED 202 to fall within the active portion of the duty cycle of the visible LED 204.

The multi-wavelength active marker 200 preferably includes a waveguide 210 for gathering and directing light emitted by LEDs 202, 204. With reference to FIG. 2B, the waveguide 210 (which may also be referred to as a light guide or light pipe) includes a first end 212 and a second end 214. As illustrated in FIG. 2A, the waveguide 210 is mechanically coupled (as is further described herein) on top of, or above, the IR LED 202 and the visible LED 204, so that the IR light (or near-IR light) and the visible light are transmitted into the first end 212 of the waveguide 210. The waveguide 210 then guides the IR light (or near-IR light) and the visible light from the first end 212 to the second end 214.

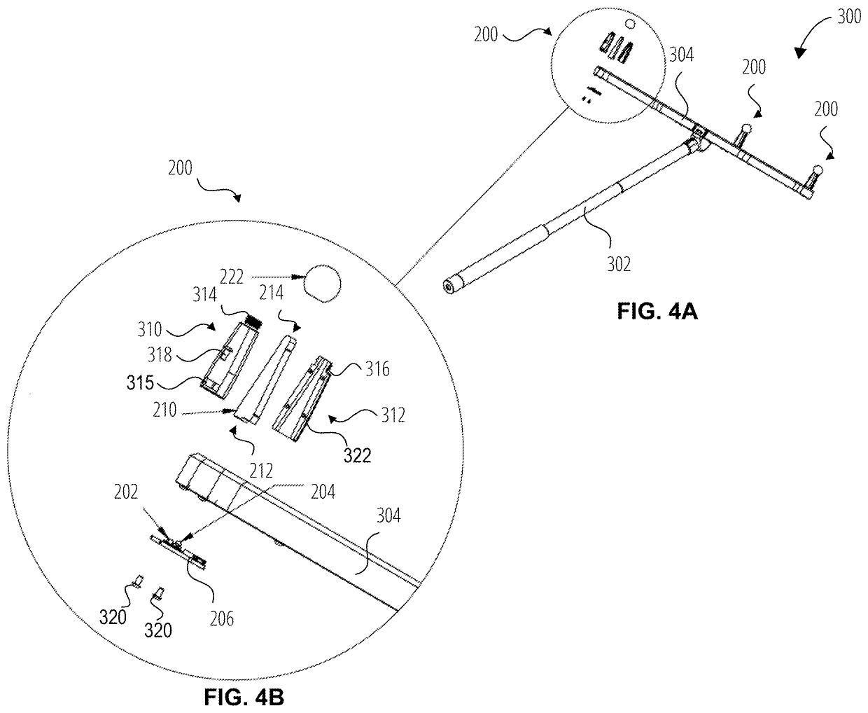

The waveguide 210 is sized and shaped to guide the IR light (or near-IR light) and the visible light through total internal reflection, or near total internal reflection, inside the waveguide 210, due to the low (oblique) angle of the sides of the waveguide 210 relative to the incident light from visible and IR LEDs 204, 202. For example, the angle of the sides of the waveguide 210 relative to the incident rays of light from LEDS 202, 204 is less than a critical angle for light in the medium of the waveguide 210 relative to the surrounding air. In some embodiments, the waveguide 210 includes an opaque cover or shield at or around the external surface of the waveguide 210, as further described below with reference to FIG. 4B (as “shell portions” 310, 312). The shield prohibits, limits, or minimizes the intrusion into waveguide 210 of ambient light that may exist in the scene 104 or the volume 110 of FIG. 1, and may further keep the outer surface of the waveguide 210 clean to promote total-internal reflection. The shield(s) may also occlude any light emitted from the sides of waveguide 210 from being visible to cameras 102. Also, in some embodiments, as is illustrated in FIG. 2B, the first end 212 (including the entry surface 216 and the entry surface 218) of the waveguide 210 has a larger (or wider) surface than the second end 214 of the waveguide 210. Therefore, the size and shape of the waveguide 210 helps converge the IR light (or near-IR light) and visible light being propagated from the first end 212 to the second end 214 of the waveguide 210.

In some embodiments, the multi-wavelength active marker 200 may utilize standard, off-the-shelf, or commercially available IR LEDs 202 and visible LEDs 204. Therefore, in some embodiments, the IR LED 202 may differ in size from the visible LED 204 (e.g., different widths, depths, and heights). Since the both the IR LED 202 and the visible LED 204 are mounted on the same substantially flat surface of the PCB 206, the first end 212 of the waveguide 210 includes an entry surface 216 and an entry surface 218 to accommodate the different sizes of the IR LED 202 and the visible LED 204, respectively (e.g., as is shown in FIG. 2B). On the other hand, the second end 214 of the waveguide 210 includes a common exit surface 220 through which both the visible and IR light from LEDs 202, 204 exits the waveguide 210. Entry surfaces 216 and 218 may each be concave, while common exit surface 220 may be convex and may be hemispherical or formed as a lens.

The multi-wavelength active marker 200 may further include a diffuser 222 coupled to the second end 214 of the waveguide 210. The diffuser 222 may be constructed using the same material as, or a different material from, the waveguide 210. For example, both of the diffuser 222 and the waveguide 210 may be constructed of transparent plastic resin material. In another example, the diffuser 222 may be constructed of glass and the waveguide 210 may be constructed using plastic, or vice versa. Regardless of whether the diffuser 222 is constructed using the same material as, or a different material from, the waveguide 210, the material of the diffuser 222 is substantially transparent to, or allows propagation of, the IR light (or near-IR light) and the visible light. For example, the diffuser 222 may be constructed using clear glass or clear plastic with a matte finish on the exterior spherical surface to promote relatively homogenous and diffused emission of light therefrom.

The diffuser 222 diffusively emits the IR light (or near-IR light) originating from IR LED 202 and the visible light originating from visible LED 204 into the capture volume 110 and/or the scene 104 of FIG. 1. The diffuser 222 preferably has a spherical emission surface, but alternative embodiments (not illustrated) may involve emission surfaces of different shapes and sizes. The spherical emission surface helps the diffuser 222 to spread out the IR light (or near-IR light) and the visible light substantially simultaneously into the scene 104 and/or the volume 110 of FIG. 1. By so doing, IR-sensitive motion capture cameras 102 of the motion-capture system 100 of FIG. 1 can sense and record the position of IR emissions from the diffuser 222, and simultaneously one or more cinema camera(s) or other reference camera(s) may sense and record the position of visible light (e.g. red light) emitted from diffuser 222, wherein the IR and visible light emitted from diffuser are coincident within the capture volume 110. In this manner, multi-wavelength active marker 200 facilitates accurate co-calibration of the IR-sensitive motion capture cameras 102 and reference cameras that are not sensitive to IR light or that are otherwise not able to sense IR light (e.g., due to the presence of an IR filter).

In some embodiments, the waveguide 210 and the diffuser 222 of the multi-wavelength active marker 200, collectively, increase the emission angles of all the light (e.g., the IR or near-IR light, and the visible light). The diffuser 222 is spaced apart from the circuit board 206 and is larger than the second end 214 of diffuser, which allows emission angles of greater than 180 degrees and up to 270 degrees or more, including emissions from an underside of the spherical diffuser 222 adjacent where it is fitted to waveguide 210. The increased emission angles facilitate visibility of the mutli-wavelength active marker 200. Thus, a user that is calibrating the motion-capture system 100 need not face the multi-wavelength active marker 200 directly toward a particular sensor and/or camera of the motion-capture system 100 of FIG. 1. Also, the increased emission angle of the multi-wavelength active marker 200 allows (or enables) a greater count of camera 102 and/or other sensors of the motion-capture system 100 of FIG. 1 to capture an image during a same time period.

In some embodiments, the waveguide 210 and the diffuser 222, collectively, cause the multi-wavelength active marker 200 to behave like having a single source that emits a first light wave having a first wavelength (e.g., IR light, near-IR light, etc.) and a second light wave having a second wavelength (e.g., visible light, red light, etc.) that is different from the first wavelength. For clarity, the IR LED 202 is located adjacent to the visible LED 204. Even though the distance between the IR LED 202 and the visible LED 204 is relatively small, these two sources still occupy different locations on the PCB 206. The waveguide 210 is shaped to cause the IR light (or near-IR light) and the visible light to converge into the common exit surface 220 of the waveguide 210. The diffuser 222 then substantially simultaneously diffuses both the IR light (or near-IR light) and the visible light into the scene 104 and/or the volume 110 of FIG. 1.

FIG. 3 shows an isometric view of a calibration wand 300 having a plurality of multi-wavelength active markers 200, in accordance with a presently preferred embodiment. In the embodiment illustrated, calibration wand 300 is T-shaped, including an elongate handle 302 and a head 304 attached to a distal end 306 of handle 302 and extending perpendicular or transversely thereto, and further including three multi-wavelength active markers 200 spaced apart along head 304. Markers 200 may be spaced apart irregularly in a predetermined pattern to facilitate identification of the orientation of wand 300. The elongated handle 302 and the head 304 are mechanically coupled using a handle end cap at distal end 306. The calibration wand 300 illustrated in FIG. 3 is not a limiting design. For example, the calibration wand 300 may include additional or fewer multi-wavelength active markers 200, may have different dimensions, may have a different shape, or combinations thereof. In some embodiments (not illustrated), the head and the handle may not be perpendicular to each other.

The use of a plurality of multi-wavelength active markers 200 (instead of only one such multi-wavelength active marker) can increase the accuracy and speed of the calibration, alignment, and/or synchronization of image sensors sensing different wavelengths, such as the motion capture cameras 102 and reference camera(s) of the motion-capture system 100.

The multi-wavelength active markers 200 may be mounted on wand 300 in an asymmetric arrangement. For example, the distance between the first and the second multi-wavelength active markers 200 may be different (e.g., greater or less) than the distance between the second and the third multi-wavelength active markers 200. This predetermined asymmetric arrangement in a predetermined spacing helps the sensors and/or the cameras 102 of the motion-capture system 100 of FIG. 1 to determine and track the motion and/or the orientation of the calibration wand 300 and its multi-wavelength active markers 200. Additionally, or alternatively, each of the multi-wavelength active markers 200 may include or emit an identifier (e.g., a code, a label, an electronic tag, which may be a pulse-modulated signal) in order to help track the motion and/or the position of the calibration wand 300 and/or specific multi-wavelength active markers 200.

In some embodiments, the elongated handle 302 may include a plurality of sections (or posts), and the sections allows a user to adjust the length of the elongated handle 302. The elongated handle 302 may be hollow and may be configured as a housing (or enclosure) for various electrical, electronic, and/or mechanical components, wiring, or combinations thereof. In some embodiments, the head 304 may also be configured as a housing (or enclosure) for various electronic, electrical, and/or mechanical components, wiring, or combinations thereof. For example, the housing of the head 304 may enclose respective PCBs 206 of the plurality of multi-wavelength active markers 200. The housing of the head 304 may include bottom covers 308. The bottom covers 308 may be mechanically coupled to the head 304 using screws (as is illustrated), clamps, or another coupling mechanism.

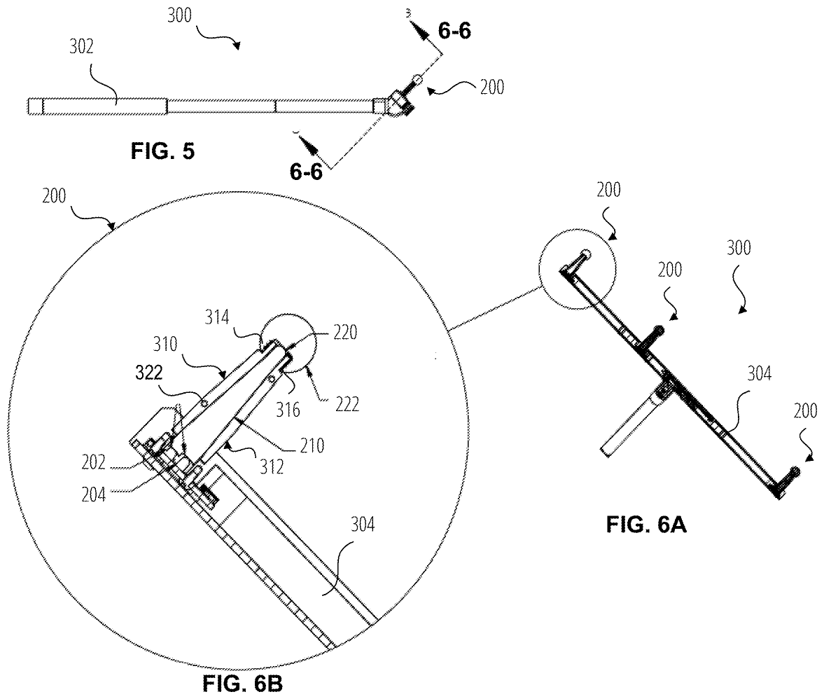

FIG. 4A is a partially-exploded isometric view of calibration wand 300 of FIG. 3A; and FIG. 4B is an enlarged isometric detail view showing details of one of the multi-wavelength active markers 200 of FIG. 4A. FIG. 5 shows a left side view of the calibration wand 300 of FIG. 3. FIG. 6A is a cross-sectional view taken along line 6-6 of FIG. 5; and FIG. 6B is an enlarged cross-sectional detail view showing detail of the head 304 of the calibration wand 300 and of the mechanical coupling and arrangement of components of the multi-wavelength active marker 200 in an assembled configuration. With reference to FIGS. 4B and 6A, multi-wavelength active marker 200 includes first and second shell portions 310 and 312, respectively, which surround, support and protect waveguide 210, and acting as an opaque shield as described above, while leaving first end 212 and common exit surface 220 of waveguide 210 exposed at respective proximal and distal ends of shell portions 310, 312. Each of the shell portions 310, 312 may include a flange or foot 315 through which a screw 318 is inserted to fasten the shell portions 310, 312 to head 304 of wand 300. Similarly, screws 320 fasten PCB 206 to head 304. Head 304 may be molded with precise holes and registration surfaces for PCB 206 and shell portions 310 to promote precise alignment between the first end 212 of waveguide 210 and LEDs 202, 204. First and second shell portions 310, 312 may further include pins and holes 322 for aligning and joining the two shell portions 310, 312 together around waveguide 210. The posts 310 may include first and second threaded portions 314, 316 which are aligned to form a complete thread onto which diffuser 222 is threadably attached adjacent exit surface 220 of waveguide 210, as best illustrated in FIG. 6B. In other embodiments, diffuser 222 may be attached to waveguide 210 by press fitting or snap-fitting the diffuser 222 to second end 214 of waveguide 210 or to the distal ends of shell portions 310, 312. In some embodiments, diffuser 222 is attached and positioned to leave an air gap between exit surface 220 and diffuser 222, thereby inhibiting back-propagation of light from diffuser 222 to waveguide 210. In other embodiments, diffuser 222 may be optically coupled to exit surface 220 of waveguide 210 by an optical adhesive or bonding material. In still other embodiments, different means of assembling the components of multi-wavelength active marker 200 and mechanically attaching it to wand 300 may be utilized.

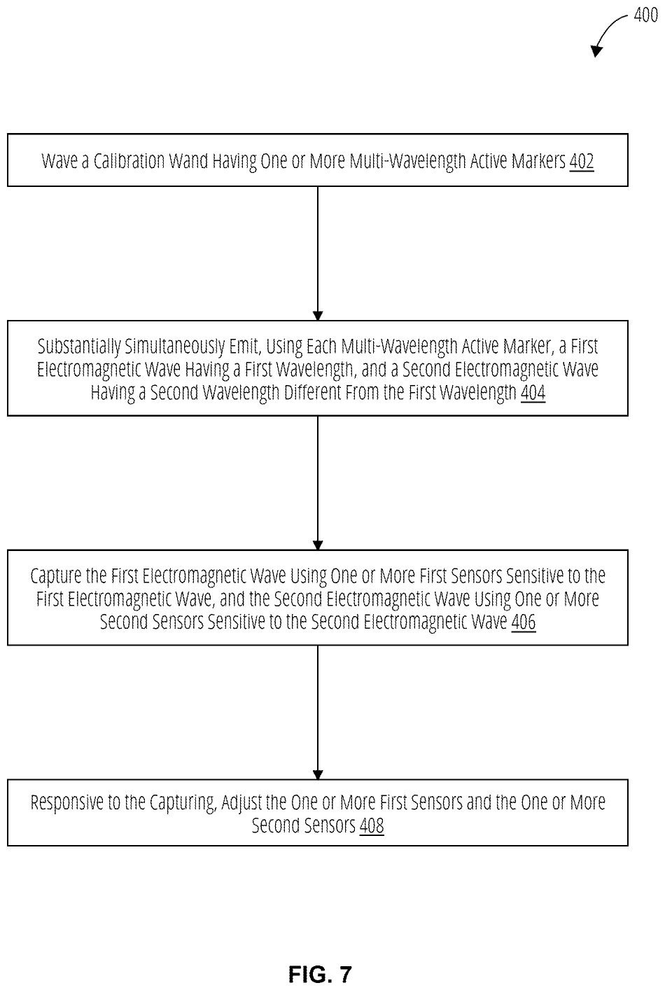

FIG. 7 is a block diagram illustrating an example method 400 for calibrating a multiple-camera system, such as the motion capture system 100 of FIG. 1, for example. The steps or stages of the method 400 depicted by blocks 402, 404, 406 of the block diagram do not necessarily need to be executed in any specific order, or even sequentially, nor need the steps be executed only once, unless otherwise specified or necessarily implied by the following description. Furthermore, the method 400 can be utilized by using one, more than one, and/or all the steps, stages, and/or blocks illustrated in FIG. 7. Therefore, the method 400 does not necessarily include a minimum, an optimal, or a maximum number of steps, stages, and/or blocks, and is a non-limiting example.

In step 402, the method 400 may include a user waving a calibration wand (e.g., the calibration wand 300 of FIG. 3), which includes one or more multi-wavelength active markers (e.g., the multi-wavelength active marker 200 of FIGS. 2A and 2B).

In step 404 of method 400, each multi-wavelength active marker of the calibration wand substantially simultaneously emits a first light wave of a first wavelength and a second light wave of a second wavelength that is different from the first wavelength. In some embodiments, the first light wave may be an IR or a near-IR light, and the second light wave may be visible light (e.g., red light or another light in the visible spectrum). In some embodiments, the multi-wavelength active marker may emit more than two light waves all having different wavelengths.

In step 406 of method 400, the first light wave is captured, sensed or recorded using one or more first image sensors sensitive to the first light wave, and the second light wave is captured, sensed or recorded using one or more second image sensors sensitive to the second light wave. In some embodiments, one or some of the cameras 102 of FIG. 1 may include the one or more first image sensors, whereas one or some other cameras 102 of FIG. 1 may include the one or more second image sensors. In some embodiments, one or some of the cameras 102 of the motion capture system 100 of FIG. 1 may include the one or more first image sensors, and one or more reference cameras or cinema cameras may include the one of more second image sensors sensitive. The second image sensors may be sensitive to the second wavelength and not sensitive to the first wavelength.

In step 408, the method 400 method may include calibrating and/or synchronizing the one or more first sensors, the one or more second sensors, and/or the cameras 102 of FIG. 1. The calibration step 408 may include calculating one or more camera projection matrices or calibration data sets. As described herein, the calibration of the one or more first sensors, the one or more second sensors, and/or the cameras 102 of FIG. 1 may include increasing an SNR of the first and the second wavelengths compared to other wavelengths of light in the scene 104 and/or the volume 110 of FIG. 1. The method 400 may also include filtering out the other wavelengths (such as ambient light, for example) from the scene 104 and/or the volume 110 of FIG. 1.

Although embodiments are described herein in the context of a motion capture system used with a reference camera, the multi-wavelength markers and calibration wands according to the present disclosure may be used with any two or more image sensors or other sensors sensing two or more different wavelengths, regardless of whether the image sensors are used for motion capture. Also, the multi-wavelength markers may be used for various purposes such as calibration, tracking, identification, and/or marking of any sort.

As described herein, in some embodiments the adjustment of the sensors and/or cameras may include determining intrinsic properties and/or extrinsic properties of each, some, or all of the sensors and/or cameras. For example, the intrinsic properties may include parameters that define lens properties, a focal length, a distortion, pixels, pixels-per-degree, an image format, a principal point, or combinations thereof of the sensors and/or cameras. As another example, the extrinsic properties may include parameters that define a position of each, some, or all of the sensors and/or cameras relative to each other, each multi-wavelength active marker, to a scene, or combinations thereof.

Having identified various components and methodologies in the present disclosure, it should be understood that any number components and arrangements may be employed to achieve the desired functionality within the scope of the present disclosure. For example, although some components are depicted as single components, many of the elements described herein may be implemented as discrete or distributed components or in conjunction with other components, and in any suitable combination and location. Some elements may be omitted altogether.

Moreover, various functions described herein as being performed by one or more entities may be carried out by hardware, firmware, and/or software, as described herein. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of examples is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies.

Further, while examples of the present disclosure may generally refer to the apparatuses, the systems, and the schematics described herein, it is understood that the techniques described may be extended to other implementation contexts.

Examples disclosed herein are intended in all respects to be illustrative rather than restrictive. It will be obvious to those having skill in the art that many changes may be made to the details of the above-described examples without departing from the underlying principles of the disclosure.

The invention claimed is:

1. A multi-wavelength active marker for use with a motion-capture system, the multi-wavelength active marker comprising:
a first source emitting a first light wave having a first wavelength;
a second source emitting a second light wave having a second wavelength different from the first wavelength;
a waveguide with a first end and a second end, wherein:
the waveguide is arranged adjacent the first source and the second source so that the first and the second light waves are transmitted into the first end of the waveguide; and
the waveguide is shaped to guide the first and the second light waves from the first end to the second end; and
a diffuser attached to the second end of the waveguide, wherein the diffuser diffuses and emits the first and the second light waves.

2. The multi-wavelength active marker of claim 1, wherein the waveguide converges the first and the second light waves from the first end to the second end.

3. The multi-wavelength active marker of claim 1, wherein the first wavelength includes infrared (IR) or near-IR light, and the second wavelength includes visible light.

4. The multi-wavelength active marker of claim 3, wherein the first wavelength consists of IR light and the second wavelength consists of red light.

5. The multi-wavelength active marker of claim 1, wherein the first source comprises a first LED, and the second source comprises a second LED.

6. The multi-wavelength active marker of claim 5, wherein the first LED comprises an IR LED or a near-IR LED, and the second LED comprises a visible light LED.

7. The multi-wavelength active marker of claim 1, wherein the first source and the second source are mounted on a printed circuit board (PCB), and wherein the first source is located adjacent to the second source.

8. The multi-wavelength active marker of claim 1, wherein the diffuser is sized and shaped so that the first and second wavelengths are emitted from the diffuser with an emission angle of more than 180 degrees.

9. The multi-wavelength active marker of claim 1, wherein the diffuser includes a spherical emission surface.

10. The multi-wavelength active marker of claim 1, wherein the first and the second light waves are emitted from the diffuser substantially simultaneously.

11. The multi-wavelength active marker of claim 1, wherein the waveguide is sized and shaped to guide the first and the second light waves through total internal reflection or near total internal reflection.

12. The multi-wavelength active marker of claim 1, further comprising a shield covering external side surfaces of the waveguide.

13. The multi-wavelength active marker of claim 1, wherein the first end of the waveguide includes a first entry surface and a second entry surface, and wherein:
the first entry surface is aligned with the first source; and
the second entry surface is aligned with the second source.

14. The multi-wavelength active marker of claim 13, wherein the first and the second light waves exit the second end of the waveguide at a common exit surface of the waveguide.

15. A motion-capture system comprising a calibration wand having one or more of the multi-wavelength active markers of claim 1.

16. The motion-capture system of claim 15, wherein the calibration wand comprises a T-shaped body with an elongated handle and a head extending transversely to the elongated handle, and a plurality of the multi-wavelength active markers supported on the head.

17. The motion-capture system of claim 15, further comprising:
one or more first image sensors sensitive to the first wavelength; and
one or more second image sensors sensitive to the second wavelength and not sensing the first light wave.

18. The motion capture system of claim 15, further comprising:
one or more first image sensors sensitive to the first wavelength and not sensing the second light wave;
one or more second image sensors sensitive to the second wavelength and not sensing the first light wave; and
one or more third image sensors sensitive to both the first and second wavelengths.

19. A method for calibrating a motion-capture system, the method comprising:
waving a calibration wand having one or more multi-wavelength active markers;
substantially simultaneously emitting from a common emission surface a first light wave having a first wavelength, and a second light wave having a second wavelength different from the first wavelength;
capturing the first light wave using one or more first sensors sensitive to the first wavelength, and capturing the second light wave using one or more second sensors sensitive to the second wavelength; and
responsive to the capturing, calibrating the one or more first sensors and the one or more second sensors.
